(19) United States
(12) Patent Application Publication
(10) Pub. No.: US 2023/0082448 A1
(43) Pub. Date: Mar. 16, 2023

(54) ADAPTIVE REDUNDANCY REDUCTION FOR EFFICIENT VIDEO UNDERSTANDING

(71) Applicants: International Business Machines Corporation, Armonk, NY (US); Massachusetts Institute of Technology, Cambridge, MA (US)

(72) Inventors: Bowen Pan, Cambridge, MA (US); Rameswar Panda, Medford, MA (US); Camilo Luciano Fosco, Buenos Aires (AR); Rogerio Schmidt Feris, West Hartford, CT (US); Aude Jeanne Oliva, Cambridge, MA (US)

(21) Appl. No.: 17/476,437

(22) Filed: Sep. 15, 2021

(51) Int. Cl. G06N 3/08; G06N 3/04; G06K 9/62

(52) U.S. Cl. CPC G06N 3/08; G06N 3/0454; G06K 9/6256

(57) ABSTRACT

For each convolution layer of a plurality of convolution layers of a convolutional neural network (CNN), apply an input-dependent policy network to determine: a first fraction of input feature maps to the given layer for which first corresponding output feature maps are to be fully computed by the layer; and a second fraction of input feature maps to the layer for which second corresponding output feature maps are not to be fully computed, but to be reconstructed from the first corresponding output feature maps. Fully computing the first corresponding output feature maps and reconstruct the second corresponding output feature maps. For a final one of the convolution layers of the plurality of convolution layers of the neural network, input the first corresponding output feature maps and the second corresponding output feature maps to an output layer to obtain an inference result.

### STATEMENT REGARDING FEDERALLY SPONSORED RESEARCH OR DEVELOPMENT

This invention was made with government support under contract number D17PC00341 awarded by the Intelligence Advanced Research Projects Activity (IARPA). The government has certain rights to this invention.

### STATEMENT REGARDING PRIOR DISCLOSURES BY THE INVENTOR OR A JOINT INVENTOR

The following disclosure(s) are submitted under 35 U.S.C. 102(b)(1)(A):

Bowen Pan, Rameswar Panda, Camilo Luciano Fosco, Chung-Ching Lin, Alex Andonian, Yue Meng, Kate Saenko, Aude Jeanne Oliva, and Rogerio Schmidt Feris, VA-RED²: Video Adaptive Redundancy Reduction, arXiv preprint arXiv:2102.07887, 2021 Feb. 15.

Bowen Pan, Rameswar Panda, Camilo Luciano Fosco, Chung-Ching Lin, Alex Andonian, Yue Meng, Kate Saenko, Aude Jeanne Oliva, and Rogerio Schmidt Feris, VA-RED²: Video Adaptive Redundancy Reduction, arXiv preprint arXiv:2102.07887, 28 Sep. 2020.

### BACKGROUND

The present invention relates to the electrical, electronic and computer arts, and more specifically, to machine learning for video recognition and the like.

Performing inference on deep learning models for videos remains a challenge due to the large amount of computational resources required to achieve robust recognition. An inherent property of real-world videos is the high correlation of information across frames which can translate into redundancy in either temporal or spatial feature maps of the models, or both. The type of redundant features depends on the dynamics and type of events in the video: static videos have more temporal redundancy while videos focusing on objects tend to have more channel redundancy.

### SUMMARY

Principles of the invention provide techniques for adaptive redundancy reduction for efficient video understanding. In one aspect, an exemplary method for improving the performance of a computer using a convolutional neural network to carry out a video processing task includes, for each convolution layer of a plurality of convolution layers of the convolutional neural network, applying an input-dependent policy network to determine: a first fraction of input feature maps to the given convolution layer for which first corresponding output feature maps are to be fully computed by the given convolution layer; and a second fraction of input feature maps to the given convolution layer for which second corresponding output feature maps are not to be fully computed by the given convolution layer, but to be reconstructed from the first corresponding output feature maps; for each convolution layer of the plurality of convolution layers of the convolutional neural network, fully computing the first corresponding output feature maps from the first fraction of input feature maps to the given convolution layer; for each convolution layer of the plurality of convolution layers of the neural network, reconstructing the second corresponding output feature maps from the first corresponding output feature maps; and for a final one of the convolution layers of the plurality of convolution layers of the neural network, inputting the first corresponding output feature maps and the second corresponding output feature maps to an output layer to obtain an inference result.

In another aspect, an exemplary apparatus includes a memory embodying computer executable instructions; and at least one processor, coupled to the memory, and operative by the computer executable instructions to perform a method including: instantiating a convolutional neural network and an input-dependent policy network; for each convolution layer of a plurality of convolution layers of the convolutional neural network, applying the input-dependent policy network to determine: a first fraction of input feature maps to the given convolution layer for which first corresponding output feature maps are to be fully computed by the given convolution layer; and a second fraction of input feature maps to the given convolution layer for which second corresponding output feature maps are not to be fully computed by the given convolution layer, but to be reconstructed from the first corresponding output feature maps; for each convolution layer of the plurality of convolution layers of the convolutional neural network, with the convolutional neural network, fully computing the first corresponding output feature maps from the first fraction of input feature maps to the given convolution layer; for each convolution layer of the plurality of convolution layers of the neural network, with the input-dependent policy network, reconstructing the second corresponding output feature maps from the first corresponding output feature maps; and, for a final one of the convolution layers of the plurality of convolution layers of the neural network, inputting the first corresponding output feature maps and the second corresponding output feature maps to an output layer of the convolutional neural network to obtain an inference result.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. Some embodiments may not have these potential advantages and these potential advantages are not necessarily required of all embodiments. For example, one or more embodiments improve the technological process of using a neural network on a computer to carry out a video processing task by reducing central processing unit (CPU) and/or memory requirements and/or reducing runtime.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a video with temporal redundancy, which can be exploited to enhance efficiency according to aspects of the invention;

FIG. 2 illustrates a framework for adaptive temporal and channel redundancy reduction for efficient video understanding according to an embodiment of the present invention;

FIG. 3 illustrates a block diagram of a system for adaptive temporal and channel redundancy reduction for efficient video understanding according to an embodiment of the present invention;

FIG. 4 illustrates dynamic convolution along temporal and channel dimensions according to an embodiment of the present invention;

FIGS. 5, 6, 7, and 8 show exemplary action recognition results achieved with an embodiment of the present invention;

FIG. 9 presents an exemplary visualization of temporal-wise feature maps achieved with an embodiment of the present invention;

FIG. 10 presents an exemplary visualization of channel-wise feature maps achieved with an embodiment of the present invention;

FIG. 11 depicts an exemplary process of learning with respect to different network layers (policy visualizations) according to an embodiment of the present invention;

FIGS. 12 and 13 present exemplary validation video clips achieved with an embodiment of the present invention;

FIG. 14 depicts a cloud computing environment according to an embodiment of the present invention;

FIG. 15 depicts abstraction model layers according to an embodiment of the present invention; and

FIG. 16 depicts a computer system that may be useful in implementing one or more aspects and/or elements of the invention, also representative of a cloud computing node according to an embodiment of the present invention.

### DETAILED DESCRIPTION

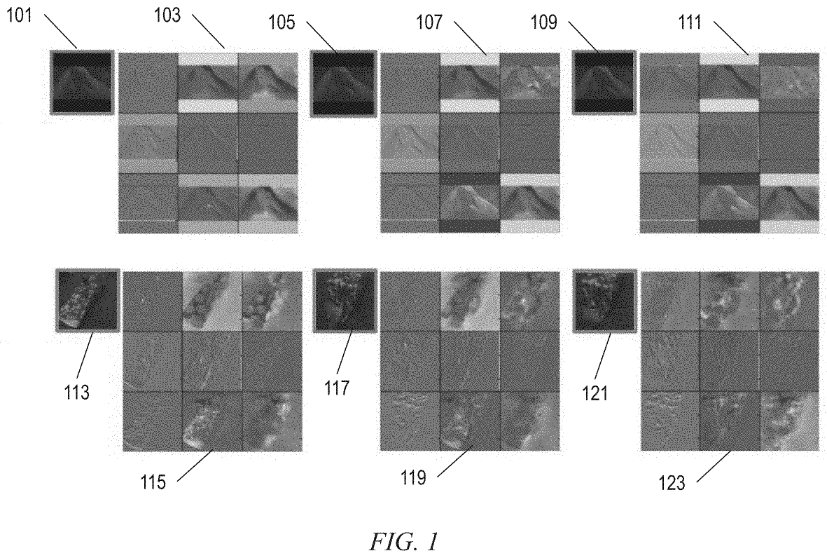

Consider video redundancy. FIG. 1 shows a visualization of the first nine filters (first three frames) of the first layer of a convolutional neural network model for video classification. The examples on the top, 101, 103, 105, 107, 109, 111, show the most redundancy in the temporal dimensions, while the examples on the bottom, 113, 115, 117, 119, 121, 123, show the least redundancy in the temporal dimension. As can be seen, the video with the most redundancy includes a relatively static video with little movement, and the sets of feature maps from frame-to-frame harbor heavy similarity. The video with the least redundancy includes a gift unwrapping with rapid movement (even in the first few frames) and the corresponding feature maps present visible structural differences from frame-to-frame. Although redundancy is present in both cases, it is clear that some examples present much more redundancy than others. One or more embodiments employ this insight to implement an input-dependent redundancy reduction approach.

The correlation coefficient (CC), root mean square error (RMSE), and redundancy proportions (RP) can be computed for feature maps in well-known pretrained video models on available datasets. In a non-limiting example, RP is calculated as the number of tensors with both CC and RMSE above redundancy thresholds of 0.85 and 0.001, respectively. In the top row of FIG. 1, CC=0.98, RMSE=0.006, and RP=0.75, while in the bottom row, CC=0.67, RMSE=0.033, and RP=0.19. Results can be obtained corresponding to averaging the per layer values for all videos in the validation sets. Redundancy may vary depending on the data set. In at least some instances, the time dimension tends to be more redundant than the channel dimension. We have found in experiments that many practical applications exhibit a large amount of redundancy (with some dataset-model pairs achieving upwards of 0.8 correlation coefficient between their feature maps), which insight is taken advantage of in one or more embodiments.

Indeed, we have found that for two exemplary data sets, two known models exhibit significant temporal (e.g., CC ranging from 0.73-0.81; RMSE ranging from 0.074-0.108; and RP ranging from 0.49 to 0.68) and channel redundancy (e.g., CC ranging from 0.68-0.76; RMSE ranging from 0.088-0.122; and RP ranging from 0.43 to 0.61).

One or more embodiments advantageously provide techniques for dynamically reducing the internal computations of various video convolutional neural network (CNN) architectures, which are model-agnostic, and hence can be applied to any state-of-the-art video recognition network.

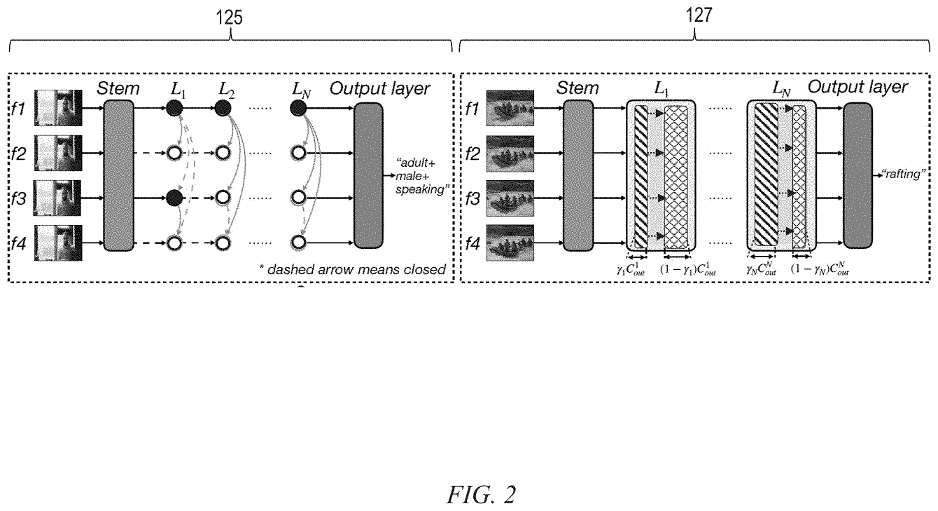

Referring to FIG. 2, a pertinent aspect in one or more embodiments is to increase efficiency by replacing full computations of some redundant feature maps with computationally inexpensive reconstruction operations. For example, only calculate the non-redundant parts of feature maps and reconstruct the remainder using computationally inexpensive linear operations from the non-redundant feature maps (in both time and channel dimensions). View 125 shows an example for adaptive temporal redundancy reduction, while view 127 shows an example for adaptive channel redundancy reduction. In view 125, the solid dots represent temporal-wise fully computed features, while the open circles represent temporal-wise cheaply-generated features. The solid straight arrows represent convolution, while the solid curved arrows represent temporal-wise cheap operations. A dashed curved arrow means the feature is cheaply reconstructed. In view 127, the single-hatched oblongs represent channel-wise fully computed features, while the double-hatched oblongs represent channel-wise cheaply-generated features. The solid straight arrows represent convolution, while the straight dashed arrows represent channel-wise cheap operations.

In a non-limiting example, compute about 50% of the features (more generally, the non-redundant portion of the features) using full convolutional calculations, and the other 50% (more generally, the redundant portion of the features) are cheaply reconstructed from the 50% done using full convolution. Other embodiments can have different percentages.

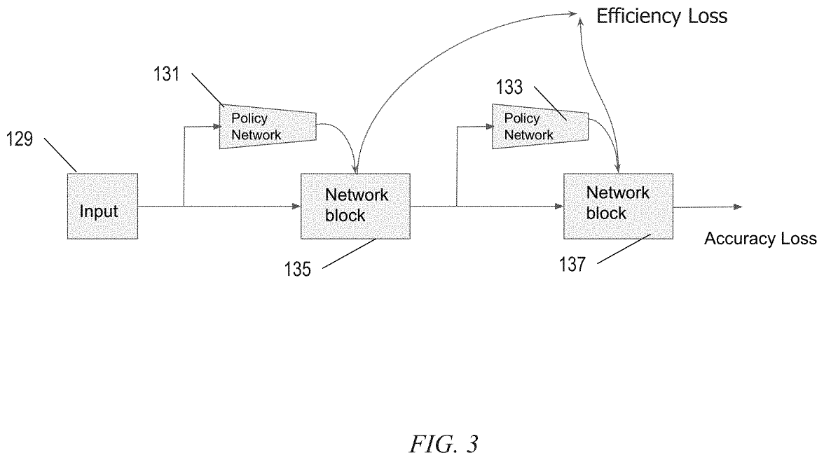

Refer now to FIG. 3. Note the input 129 and network blocks 135, 137. A standard video recognition model would merely proceed from input 129 to block 135 and to block 137, making full convolutional calculations. However, one or more embodiments employ lightweight policy networks 131, 133 to determine how much to compute. Given the input, the policy network determines that, say, 50% of the features (more generally, the non-redundant portion of the features) should be computed using full convolutional calculations, while the remainder can be cheaply reconstructed. That is to say, learn an input-dependent policy that defines a “full computation ratio” for each layer of a two-dimensional/three-dimensional (2D/3D) network. The policy networks 131, 133 are respectively dependent on the input 129 and the output of the previous stage 135. In general, the percentage of features to be fully computed will vary by input. When the input exhibits a relatively high degree of redundancy, the percentage of features to be fully calculated by convolution will be less than when the input exhibits a relatively low degree of redundancy.

Two losses are noted in the system of FIG. 3. One is the standard accuracy loss at the output of the last network block 137. The other is an efficiency loss at each network block 135, 137. In one or more embodiments, the acceptable efficiency loss determines the percentage of features to be fully calculated.

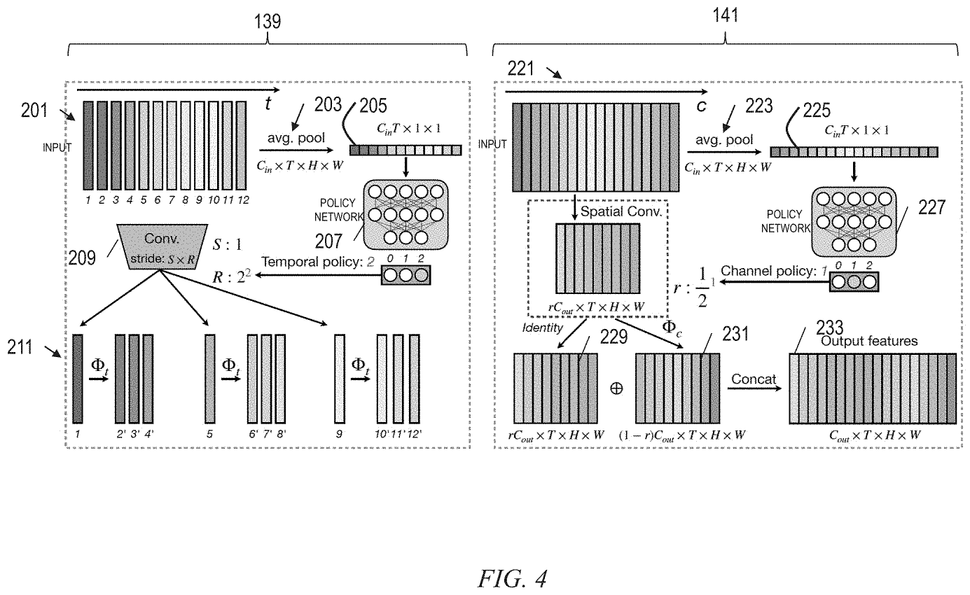

Refer now to FIG. 4. View 139 shows temporal-wise dynamic convolution while view 141 shows channel-wise dynamic convolution. Φₜ and Φₛ represent the temporal cheap operation and spatial cheap operation respectively. At 139, multiply the temporal stride S 209 with the factor R=2**pₜ to reduce computation, where pₜ is the temporal policy output by the soft modulation gate and “**” represents exponentiation. At 141, compute part of the output features with the ratio of r=(½)**p_{c}, where p_{c} is the channel policy and “**” represents exponentiation. In view 139, the output “2” of the policy network is squared and inverted to obtain ¼ such that only ¼ of the feature map is fully convolutionally calculated, while the remaining % is determined via a cheap calculation. It can be seen at the bottom of view 139 that one feature map “1” is used to construct three feature maps “2′, 3′, 4′” and so on. It can further be seen that the input has twelve feature maps. Maps 1, 5, and 9 are fully convolved and are used to cheaply construct, respectively, maps 2′, 3′, 4′; 6′, 7′, 8′; and 10′, 11′, 12′. Additional discussion of view 139, and discussion of view 141, are provided below.

Thus, with reference to view 139 (temporal policy), the input 201 includes 12 features. At 203, carry out average pooling to obtain a single feature 205. That single feature is provided to the policy network 207. The policy network provides a policy decision pₜ selected from {0, 1, 2}. If the decision is 2, 2²=4 (R=2**pₜ), then 1/R=¼ or 25% of the features are computed by full convolution and the balance are cheaply reconstructed. Thus, out of the 12 features, fully compute 1, 5, and 9 and cheaply reconstruct the rest as described above. The output 211 thus includes 12 features, 3 of which (1, 5, 9) are fully computed and 9 cheaply reconstructed.

With reference to view 141 (spatial policy/channel dimension), there are 18 input channels at input 221. Via concatenation and average pooling at 223, obtain a single feature vector 225. Pass that feature vector through the policy network 227. The policy network provides a policy decision p_{c} selected from {0, 1, 2}. If the decision is 1, r=(½)**p_{c}=½. Then ½ or 50% of the channels are computed by full convolution and the balance are cheaply reconstructed. The fraction of features r are computed normally at 229 while the fraction of features (1-r) are cheaply reconstructed at 231. The results are concatenated to obtain 18 output channels at 233; 9 determined by full spatial convolution and 9 by cheap reconstruction.

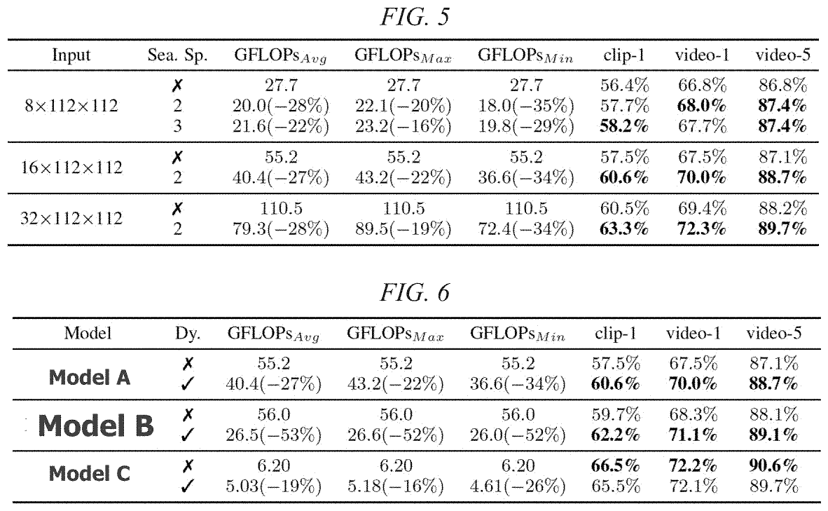

Refer now to the tables of FIGS. 5 and 6. The inputs are, respectively, 8 frames of size 112×112; 16 frames of size 112×112; and 32 frames of size 112×112. The cross mark corresponds to standard prior-art computation without compression; i.e., all feature maps are computed via conventional full convolution. The notations “2” and “3” refer, respectively, to the case where the policy network determines to predict two maps for each fully calculated map or three maps for each fully calculated map. The reduction in average, maximum, and minimum GFLOPs can be seen. The last three columns of FIG. 5 show the accuracy for clip-1, video-1, and video-5. FIG. 5 shows detailed results for one model (“Model A”) while FIG. 6 shows results for three different models (“Model A,” “Model B,” and “Model C”). The model agnostic nature of one or more embodiments can be seen, as well as a 20-40% reduction in computation with regard to existing methods. The clip-1, video-1 and video-5 metrics refer respectively to the top-1 accuracy of model evaluation with only one clip sampled from video, and the top-1 and top-5 accuracy of the model evaluated with the K-LeftCenterRight strategy (K-LeftCenterRight strategy: K temporal clips are uniformly sampled from the whole video, on which the left, center and right crops are sampled along the longer spatial axis, with the final prediction obtained by averaging).

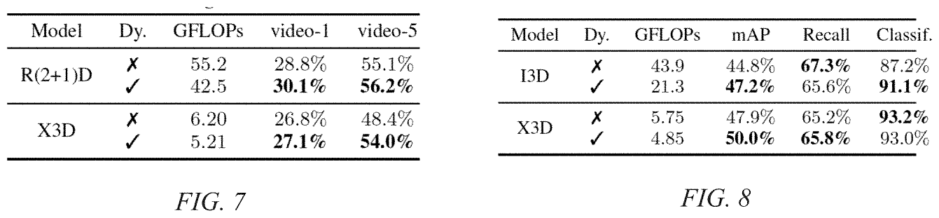

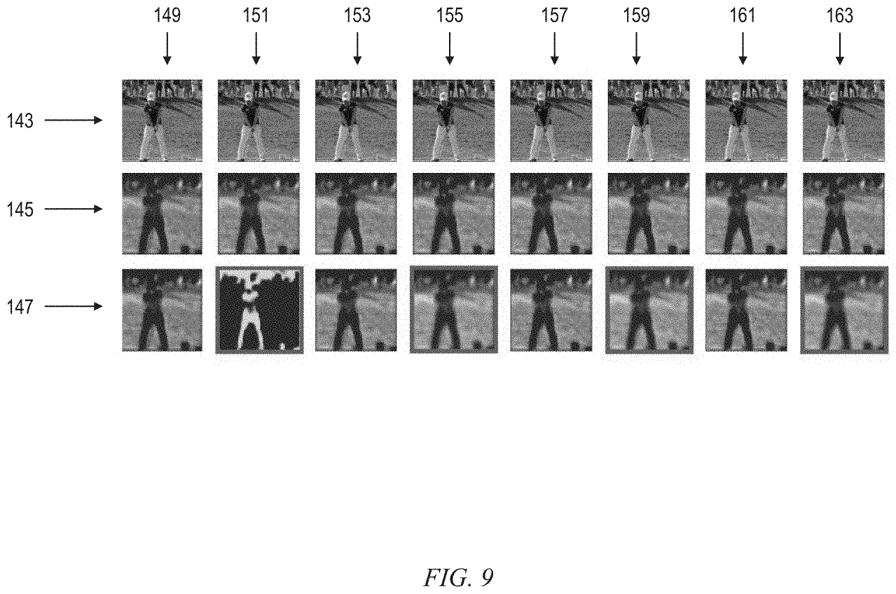

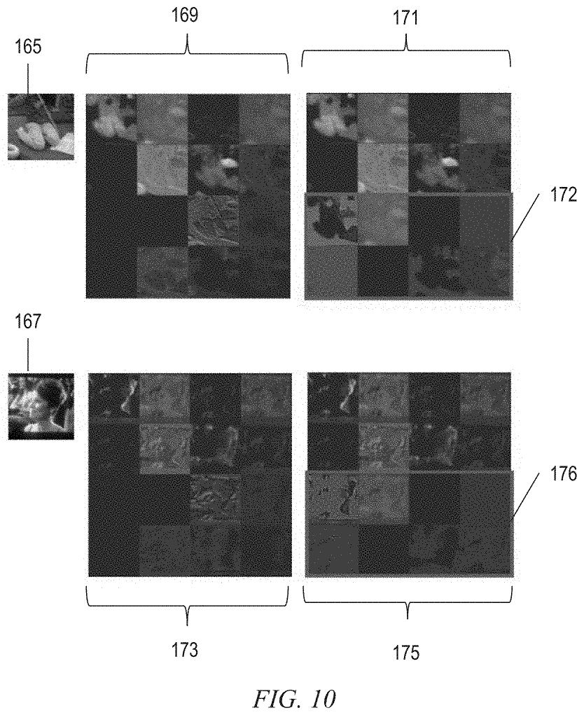

The table of FIG. 7 shows exemplary action recognition results while the table of FIG. 8 shows exemplary action localization results. One or more embodiments are broadly applicable to video recognition, video classification, and video action localization—indeed, any video understanding task. FIG. 9 shows exemplary temporal-wise feature maps while FIG. 10 shows exemplary channel-wise feature maps. In FIG. 9, row 143 shows the input frames, row 145 shows the original feature maps, and row 147 shows feature maps created with an exemplary embodiment of the invention. These feature maps are the output of the first spatial convolution combined with rectified linear activation function or (ReLU). For example, there are different blocks in the network; e.g., (ResBlock=resident block) ResBlock_1, ResBlock_2, ResBlock_3, and ResBlock_4. In one or more embodiments, Combine ResBlock_1 with ReLU of ResBlock_1, and so on. It can be seen that most of the cheaply generated feature maps (row 147 columns 151, 155, 159, 163) look no different from the original feature maps in row 145, which further supports validity of the approach adopted in one or more embodiments. Row 147 columns 149, 153, 157, 161 are calculated precisely from full convolution and are identical to row 145 columns 149, 153, 157, 161. In FIG. 10, elements 165, 167 are the input frames, elements 169, 173 are the original feature maps, and elements 171, 175 are feature maps created with an exemplary embodiment of the invention. Comparing 169 (original feature map for input 165) to 171 (fully calculated at top with bottom 172 cheaply reconstructed) and 173 (original feature map for input 167) to 175 (fully calculated at top with bottom 176 cheaply reconstructed), it will be appreciated by the skilled artisan that the feature maps generated in accordance with aspects of the invention are sufficiently similar to the original feature maps, which further supports validity of the approach adopted in one or more embodiments.

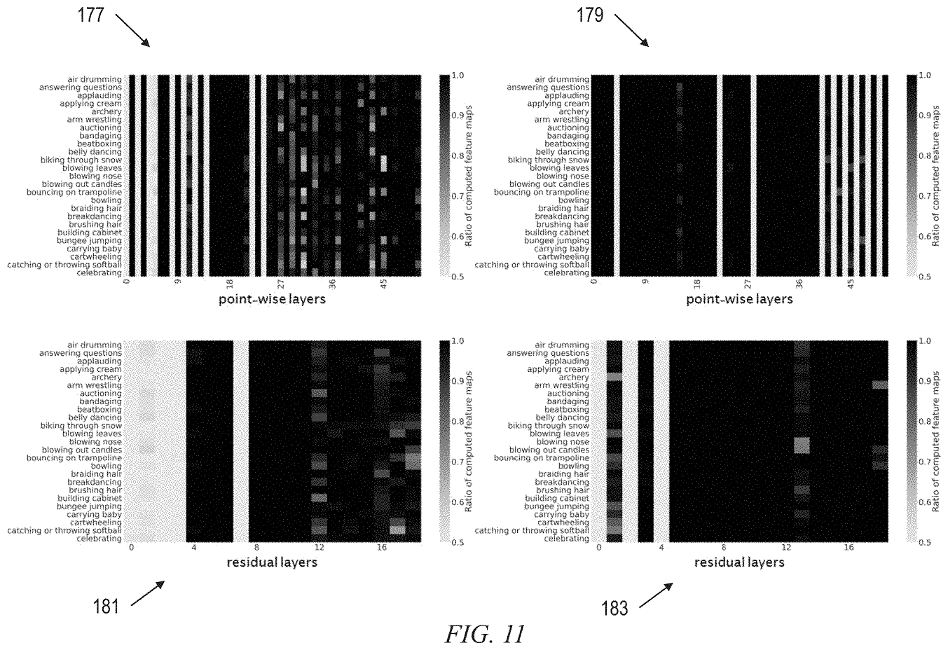

Refer now to FIG. 11, which shows a process of learning with respect to different network layers (policy visualizations). Views 177, 181 show channel-wise policies for two different models while views 179, 183 show temporal-wise policies for two different models. It is seen that channel-wise policies generally exhibit more variation than temporal-wise policies among different categories. Different categories (air drumming, answering questions, . . . ) generally require different amounts of computation. Views 177, 179 are for point-wise layers, while views 181, 183 are for residual layers. Each view shows the ratio of computed feature per layer and class on a certain data set. To generate the examples of FIG. 11, in our experiments, we picked the first 25 classes of a certain data set and visualized the per-block policy of two different models on each class. Lighter grayscale shades mean relatively fewer feature maps are computed while darker grayscale shades mean relatively more feature maps are computed. In the model for 177, 179, point-wise convolutions come right after the depth-wise convolutions and have more variation among classes; the network tends to consume more temporal-wise features at the early stage and compute more channel wise features at the late stage of the architecture. However, the model for 181, 183 chooses to select fewer features at the early stage by both temporal-wise and channel-wise policies. This is because the model for 181, 183 has heavier computation in its initial layers.

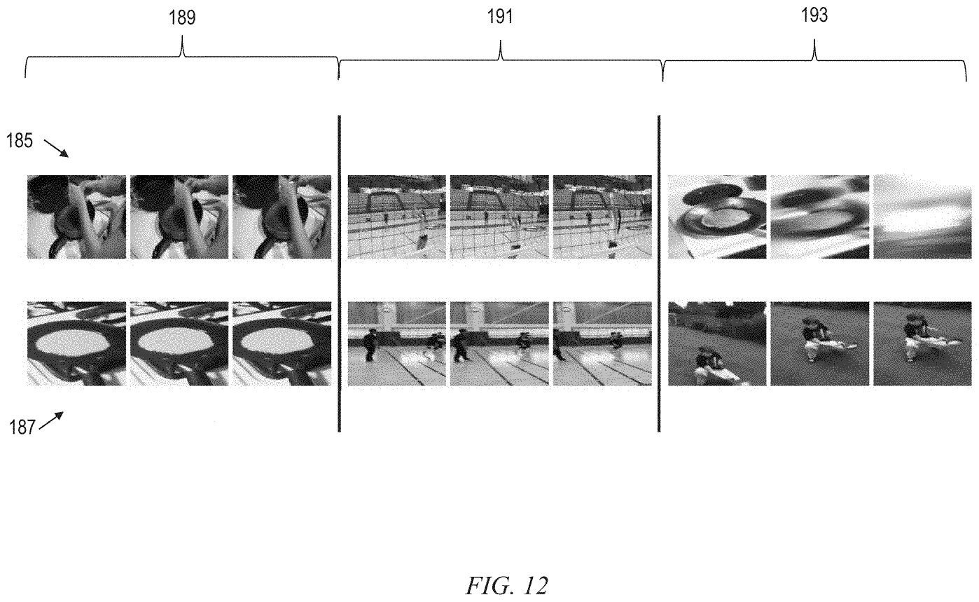

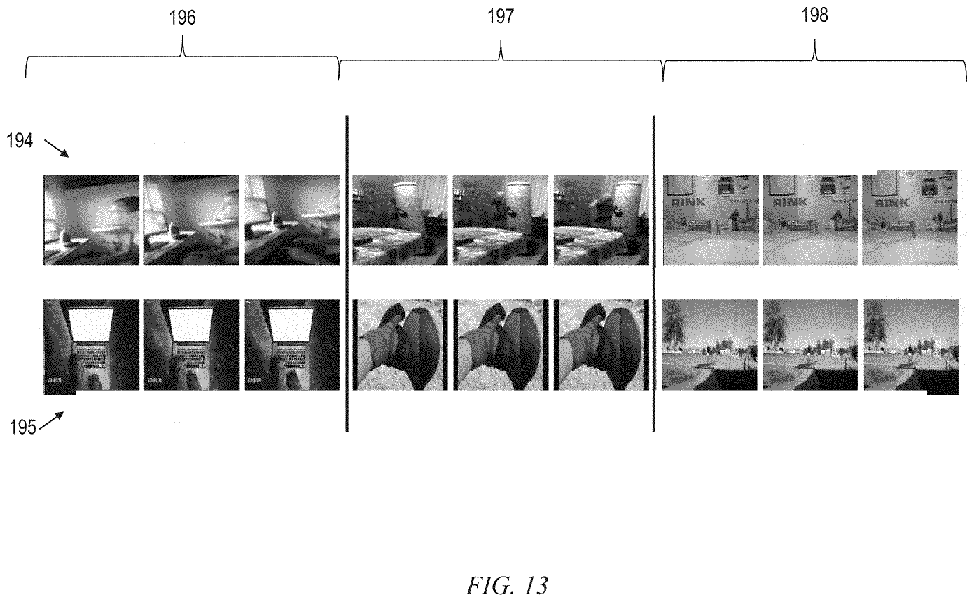

FIG. 12 shows exemplary results on a first data set. In each of views 189, 191, 193, the top row 185 (harder to classify) requires more computation than the bottom row 187 (easier to classify). Video clips which have a more complicated scene configuration (e.g., top row for cooking eggs 189 and playing volleyball 191) and more violent camera motion (e.g., top row for flipping a pancake 193) tend to need more feature maps to obtain the correct predictions. FIG. 13 shows exemplary results on a second data set. In each of views 196, 197, 198, the top row 194 (harder to classify) requires more computation than the bottom row 195 (easier to classify). In general, video clips which have a more complicated scene configuration, more violent camera motion, and/or more movement/action tend to need more feature maps to obtain the correct predictions.

Thus, it will be appreciated that performing inference on deep learning models for videos remains a challenge due to the large amount of computational resources required to achieve robust recognition. As noted, an inherent property of real-world videos is the high correlation of information across frames, which can translate into redundancy in either temporal or spatial feature maps of the models, or both. The type of redundant features, as also noted, depends on the dynamics and type of events in the video: static videos have more temporal redundancy while videos focusing on objects tend to have more channel redundancy. One or more embodiments provide a redundancy reduction framework, referred to herein as VA-RED2 (Video Adaptive REDundancy REDuction), which is input-dependent. Specifically, a framework in accordance with one or more embodiments uses an input-dependent policy to decide how many features need to be computed for temporal and channel dimensions. To keep the capacity of the original model, after fully computing the necessary features, one or more embodiments reconstruct the remaining redundant features from the fully computed ones using cheap linear operations. One or more embodiments learn the adaptive policy jointly with the network weights in a differentiable way with a shared-weight mechanism, making them highly efficient. Extensive experiments on multiple video datasets and different visual tasks show that an exemplary framework achieves 20% to 40% reduction in computation (FLOPs) when compared to state-of-the-art methods, without any performance loss.

Large computationally expensive models based on 2D/3D convolutional neural networks (CNNs) are widely used in video understanding; thus, the increased computational efficiency provided by one or more embodiments is advantageous. Heretofore, approaches have focused on architectural changes in order to maximize network capacity while maintaining a compact model or improving the way that the network consumes temporal information. Nevertheless, current CNNs typically perform unnecessary computations at some levels of the network, especially for video models, since the high appearance similarity between consecutive frames results in a large amount of redundancy.

Advantageously, one or more embodiments dynamically reduce the internal computations of popular video CNN architectures, leveraging the existence of highly similar feature maps across both time and channel dimensions in video models. Furthermore, this internal redundancy varies depending on the input: for instance, static videos will have more temporal redundancy whereas videos depicting a single large object moving tend to produce a higher number of redundant feature maps. To reduce the varied redundancy across channel and temporal dimensions, one or more embodiments provide an input-dependent redundancy reduction framework (as noted, called VA-RED2) for efficient video recognition (FIG. 2 presents an illustrative example). One or more embodiments are, advantageously, model-agnostic, and hence can be applied to any state-of-the-art video recognition networks.

A framework in accordance with one or more embodiments dynamically reduces the redundancy in two dimensions. View 125 shows a case where the input video has little movement. The features in the temporal dimension are highly redundant, so the exemplary framework fully computes a subset of features, and reconstructs the rest with cheap linear operations. In the view 127, it is seen that the exemplary framework can reduce computational complexity by performing a similar operation over channels: only part of the features along the channel dimension are computed, and cheap operations are used to generate the rest.

A pertinent mechanism used by one or more embodiments to increase efficiency is to replace full computations of some redundant feature maps with cheap reconstruction operations. Specifically, a framework in accordance with one or more embodiments avoids computing all the feature maps. Instead, only calculate the non-redundant part of the feature maps and reconstruct the rest from the non-redundant feature maps using cheap linear operations. In addition, one or more embodiments make decisions on a per-input basis: an exemplary framework learns an input-dependent policy that defines a “full computation ratio” for each layer of a 2D/3D network. This ratio determines the amount of features that will be fully computed at that layer, versus the features that will be reconstructed from the non-redundant feature maps. One or more embodiments apply this strategy on both time and channel dimensions. In our experiments, we have found that for both traditional video models and more advanced models, one or more embodiments significantly reduce the total floating point operations (FLOPs) on common video datasets without accuracy degradation.

One or more embodiments advantageously provide: (1) a novel input-dependent adaptive framework for efficient video recognition, which automatically decides what feature maps to compute per input instance; (2) an adaptive policy jointly learned with the network weights in a fully differentiable way with a shared-weight mechanism, that allows making decisions on how many feature maps to compute; (3) striking results over baselines, with a 20%-40% reduction in computation in comparison to prior art techniques, with little or no performance loss, for the video action recognition task; and/or (4) generalizability to video action recognition, spatio-temporal localization, and semantic segmentation tasks, achieving promising results while offering significant reduction in computation over competing methods. One or more embodiments are model-agnostic and can be applied to any backbones to reduce feature redundancy in both time and channel domains.

One or more embodiments automatically decide which feature maps to compute for each input video in order to classify the video correctly with the minimum computation. One or more embodiments leverage the fact that there are many similar feature maps along the temporal and channel dimensions. For each video instance, one or more embodiments estimate the ratio of the feature maps that need to be fully computed along the temporal dimension and the channel dimension, and then, for the other feature maps, reconstruct them from those pre-computed feature maps using cheap linear operations.

Without loss of generality, start from a 3D convolutional network ϑ, and denote its l^{th} 3D convolution layer as fₗ, and the corresponding input and output feature maps as Xₗ and Yₗ respectively. For each 3D convolution layer, use a very lightweight (i.e., less complex as compared to the full convolutional calculations) policy layer pₗ denoted as a soft modulation gate to decide the ratio of feature maps along the temporal and channel dimensions which need to be computed. As shown in FIG. 4 location 139, for temporal-wise dynamic inference, reduce the computation of a 3D convolution layer by dynamically scaling the temporal stride of the 3D filter with a factor R=2**(pₗ(Xₗ) [0]). Thus, the shape of the output Yₗ′ becomes Cₒᵤₜ×Tₒ/R×Hₒ×Wₒ. To keep the same output shape, reconstruct the remaining features based on Yₗ′ as:

$${Y}_{l} [ j + iR ] = \{ \begin{matrix}{Φ}_{i , j}^{t} ( {Y}_{l}^{′} [ i ] ) & if j ∈ \{ 1 , … , R - 1 \} \\ {Y}_{l}^{′} [ i ] & if j = 0\end{matrix} , i ∈ \{ 0 , 1 , … , {T}_{o} / R - 1 \} \qquad ( 1 )$$

In the above, Yₗ[j+iR] represents the (j+iR)^{th} feature map of Yₗ along the temporal dimension, Yₗ′[i] denotes the i^{th} feature map of Yₗ′, and Φ_{i,j}^{t} is the cheap linear operation along the temporal dimension.

The total computational cost of this process can be written as:

$$𝒞 ( {f}_{l}^{t} ) = \frac{1}{R} \cdot 𝒞 ( {f}_{l} ) + {\sum }_{i , j} 𝒞 ( {Φ}_{i , j}^{t} ) \approx \frac{1}{R} \cdot 𝒞 ( {f}_{l} ) \qquad ( 2 )$$

In the above, the function C(⋅) returns the computation cost for a specific operation, and fₗ^{t} represents a dynamic convolution process along the temporal dimension. Different from temporal-wise dynamic inference, one or more embodiments reduce the channel-wise computation by dynamically controlling the number of output channels. Scale the output channel number with a factor r=(½)**(pₗ(Xₗ) [1]). In this case, the shape of the output Yₗ′ is rCₒᵤₜ×Tₒ×Hₒ×Wₒ. As before, reconstruct the remaining features via cheap linear operations, which can be formulated as Yₗ=[Yₗ′, Φ^{C} (Yₗ′)], where Φ^{c} (Yₗ′)∈R**((1−r)(Cₒᵤₜ×T₀×H₀×W₀)) represents the cheaply generated feature maps along the channel dimension, and Yₗ∈R**(Cₒᵤₜ×T₀×H₀×W₀) is the output of the channel-wise dynamic inference. The total computation cost of joint temporal-wise and channel-wise dynamic inference is:

$$𝒞 ( {f}_{l}^{t , c} ) \approx \frac{r}{R} \cdot 𝒞 ( {f}_{l} ) \qquad ( 3 )$$

In the above, fₗ^{t,c} is the adjunct process of temporal-wise and channel-wise dynamic inference.

Consider use of the aforementioned soft modulation gate for differentiable optimization. One or more embodiments adopt an extremely lightweight (i.e., less complex as compared to the full convolutional calculations) policy layer pₗ, called a soft modulation gate, for each convolution layer fₗ to modulate the ratio of features which need to be computed. Specifically, the soft modulation gate takes the input feature maps Xi as input and learns two probability vectors Vₜ^{l}∈R**Sₜ and V_{c}^{l}∈R**S_{c}, where Sₜ and S_{c} are the temporal search space size and the channel search space size, respectively. The Vₜ^{l} and V_{c}^{l} are learned by:

[Vₜ^{l},V_{c}^{l}]=pₗ(Xₗ)=ϕ( [symbol] (ω_{p,2},δ( [symbol] ( [symbol] (ω_{p,1},G(Xₗ)))))+βₚ^{l}) (4)

In the above, [symbol] ,⋅) denotes the fully-connected layer; N is the batch normalization; δ(·) represents the tan h(⋅) function; G is the global pooling operation whose output shape is Cᵢₙ·T×1×1; φ(⋅) is the output activation function—one or more embodiments just use max(tan h(⋅), 0) whose output range is [0, 1); ω_{p,1}∈R**((Sₜ+S_{c})×Dₕ), ω_{p,2}∈R**(Dₕ×Cᵢₙ·T), are the weights of their corresponding layers; and Dₕ is the hidden dimension number. Vₜ^{l} and V_{c}^{l} will then be used to modulate the ratio of the feature maps to be computed in temporal-wise dynamic convolution and channel-wise dynamic convolution. During training, obtain the final output of the dynamic convolution by a weighted sum of all the feature maps, which contains different ratios of fully-computed features as follows:

$${Y}_{𝒸}^{l} = {\sum }_{i = 1}^{{S}_{𝒸}} {V}_{𝒸}^{l} [ i ] \cdot {f}_{l}^{𝒸} ( {X}_{l} , r = {( \frac{1}{2} )}^{( i - 1 )} ) , \\ {Y}_{l} = {\sum }_{j = 1}^{{S}_{t}} {V}_{t}^{l} [ j ] \cdot {f}_{l}^{t} ( {Y}_{𝒸}^{l} , R = {2}^{( j - 1 )} ) \qquad ( 5 )$$

In the above, fₗ^{c} (⋅, r) is the channel-wise dynamic convolution with the channel scaling factor r, and fₗ^{t} (⋅, R) is the temporal-wise dynamic convolution with the temporal stride scaling factor R. During the inference phase, only the dynamic convolutions whose weights are not zero will be computed.

Consider shared-weight training and inference. Many approaches to adaptive computation and neural architecture search exhibit heavy computational cost and memory usage during the training stage due to the large search space. Under a naive implementation, the training computational cost and parameter size would linearly grow as the search space size increases. To train efficiently, one or more embodiments utilize a weight-sharing mechanism to reduce the computational cost and training memory. One or more embodiments first compute all the possible necessary features. Then, for each dynamic convolution with a different scaling factor, one or more embodiments sample the corresponding ratio of necessary features and reconstruct the rest of the features by cheap operations to obtain the final output. Though this approach, one or more embodiments are able to keep the computational cost at a constant value invariant to the search space. More details on this are included in Details of Shared-weight Training and Inference below.

Consider efficiency loss. To encourage an exemplary network to output a computationally efficient subgraph, one or more embodiments introduce the efficiency loss [symbol] during the training process, which can be formulated as:

$${ℒ}_{e} = {( {μ}_{0} {{\sum }_{l = 1}}^{L} \frac{𝒞 ( {f}_{l} )}{{\sum }_{k = 1}^{L} 𝒞 ( {f}_{k} )} \cdot \frac{{r}_{l}^{s}}{{R}_{l}^{s}} )}^{2} , {μ}_{0} = \{ \begin{matrix}1 if correct \\ 0 otherwise\end{matrix} \qquad ( 6 )$$

In the above, rₗ^{s} is a channel scaling factor of the largest filter in the series of channel-wise dynamic convolutions, and Rₗ^{s} is the stride scaling factor of the largest filter of the temporal-wise dynamic convolutions. Overall, the loss function of the whole framework can be written as [symbol] = [symbol] +λ [symbol] , where [symbol] is the accuracy loss of the whole network and λₑ is the weight of efficiency loss which can be used to balance the importance of the optimization of prediction accuracy and computational cost.

One or more embodiments thus provide an input-dependent adaptive framework for efficient inference which can be easily plugged into most existing video understanding models to significantly reduce the model computation while maintaining accuracy. Experimental results on video action recognition, spatio-temporal localization, and semantic segmentation validate the effectiveness of an exemplary framework in multiple standard benchmark datasets.

Details of Shared-weight Training and Inference: consider additional details of the shared-weight mechanism. First, compute all the possible necessary features and then for each dynamic convolution with a different scaling factor, sample its corresponding ratio of necessary features and reconstruct the rest of the features by cheap operations to obtain the final output. For example, the original channel-wise dynamic convolution at ratio r=(½)⁽ⁱ⁻¹⁾ can be analogized to:

[(fₗ^{c}(Xₗ,r=(½)ⁱ^{ₛ}^{^{c}}⁻¹)[0:(½)⁽ⁱ⁻¹⁾Cₒᵤₜ]),

(Φ^{c}(fₗ^{c}(Xₗ,r=(½)ⁱ^{ₛ}^{^{c}}⁻¹)[0:(½)⁽ⁱ⁻¹⁾·Cₒᵤₜ]))] (7)

In the above, [⋅:⋅] is the index operation along the channel dimension, and iₛ^{c} is the index of the largest channel-wise filter. During the training phase, iₛ^{c}=1, while during the inference phase, iₛ^{c} is the smallest index for V_{c}^{l}, s.t. V_{c}^{l} [iₛ^{c}]=0. By utilizing such a share-weight mechanism, the computation of the total channel-wise dynamic convolution is reduced to ((½)**(iₛ^{c}−1))·C(fₗ). Further, the total computational cost of the adjunct process is given by:

C(fₗ^{t,c})=(½)ⁱ^{ₛ}^{^{c}}⁺ⁱ^{ₛ}^{^{t}}⁻²·C(fₗ) (8)

In the above, iₛ^{t} is the index of largest temporal-wise filter.

One or more embodiments address efficient video understanding by adaptively reducing the feature redundancy per input basis, not merely processing the same frames irrespective of the input. One or more embodiments provide techniques that employ an input-dependent policy to automatically decide how many features need to be computed for temporal and channel dimensions, and end-to-end. One or more embodiments thus enhance efficiency as compared to prior art techniques wherein feature redundancy across both time and channel dimensions is not directly mitigated. Further, one or more embodiments are model-agnostic and hence can be applied to any state-of-the-art video recognition network, as opposed to those prior art techniques that are, for example, specific to one certain type of CNN.

One or more embodiments provide techniques for efficient video understanding. One or more embodiments include an end-to-end framework; i.e., a single computational unit processes and classifies the video, as opposed to those prior-art techniques that require multiple subcomponents working independently. One or more embodiments provide both accuracy and efficiency required for many resource-constrained applications. One or more embodiments advantageously require less computation and lower memory by replacing full computations of some redundant feature maps with cheap reconstruction operations. One or more embodiments provide a framework that is well-suited for resource constrained or edge artificial intelligence (AI) applications. One or more embodiments are based, for example, on deep learning (Convolutional Neural Networks (CNNs)).

One or more embodiments dynamically reduce the internal computations of popular video CNN architectures. One or more embodiments provide a framework that is input dependent, inasmuch as the type of redundant features depends on the dynamics and type of events in the video: static videos have more temporal redundancy while videos focusing on objects tend to have more channel redundancy. In contrast, prior art techniques typically utilize the same amount of computation for all the videos regardless of the nature and content of the video. As a result, one or more embodiments are significantly more efficient than such prior art techniques. One or more embodiments can be applied to any type of video understanding tasks, such as video action recognition, spatio-temporal localization, and dense video tasks such as segmentation, to significantly reduce computation without any accuracy degradation. One or more prior art techniques, in contrast, are limited to action recognition without considering efficiency. Indeed, one or more prior art techniques are static while one or more embodiments are dynamic. Specifically, one or more embodiments are input dependent which is in contrast to prior art static methods that neglect the input-dependent feature redundancy of video CNNs. One or more embodiments provide efficient video action understanding, and hence are more suitable for surveillance and behavior analysis than typical prior art techniques.

One or more embodiments thus provide techniques for using a computing device to improve object image recognition within a digital video. For example, an exemplary method includes receiving, by a computing device, a digital video for object image recognition; analyzing, by the computing device, a plurality of still images which form the digital video; determining, by the computing device, which of the plurality of still images indicate redundant objects; and recognizing, by the computing device, only objects within the digital video which are not redundant.

Another exemplary method, for dynamically reducing the redundant computation in video understanding models, avoids computation of all the feature maps. The approach only computes the non-redundant part of the feature maps and reconstructs the rest using cheap linear operations from the non-redundant feature maps.

One or more embodiments provide a novel input-dependent adaptive framework for efficient video understanding, that automatically decides what feature maps to compute per input instance; an adaptive policy jointly learned with the network weights in a fully differentiable way with a shared weight mechanism, that allows for making decisions regarding how many feature maps to compute; and/or a model-agnostic approach that can be applied to any backbones to reduce feature redundancy in both time and channel domains.

Given the discussion thus far, it will be appreciated that, in general terms, an exemplary method for improving the performance of a computer using a convolutional neural network to carry out a video processing task includes, for each convolution layer 135, 137 of a plurality of convolution layers of a convolutional neural network, applying an input-dependent policy network 131, 133 to determine: a first fraction of input feature maps to the given convolution layer for which first corresponding output feature maps are to be fully computed by the given convolution layer; and a second fraction of input feature maps to the given convolution layer for which second corresponding output feature maps are not to be fully computed by the given convolution layer, but to be reconstructed from the first corresponding output feature maps. This step can be carried out, for example, using a trained policy network to calculate r and R as described above.

A further step includes, for each convolution layer of the plurality of convolution layers of the convolutional neural network, fully computing the first corresponding output feature maps from the first fraction of input feature maps to the given convolution layer. This step can be carried out, for example, using any suitably trained conventional convolutional neural network.

A still further step includes, for each convolution layer of the plurality of convolution layers of the neural network, reconstructing the second corresponding output feature maps from the first corresponding output feature maps. This step can be carried out, for example, using the trained policy network (see discussion of Φₜ and Φₛ).

An even further step includes, for a final one of the convolution layers of the plurality of convolution layers of the neural network, inputting the first corresponding output feature maps and the second corresponding output feature maps to an output layer to obtain an inference result. The skilled artisan will have general familiarity with convolutional neural networks and neural network output layers and their implementation on a computer.

The policy network can be implemented on a computer by coding the logic in the equations set forth herein in, for example, a high-level programming language compiled or interpreted into computer-executable code. In one or more embodiments, for example, simultaneously jointly train the convolutional neural network and the policy network. As noted, one or more embodiments learn the adaptive policy jointly with the network weights in a differentiable way with a shared-weight mechanism, making it highly efficient—the policy and main networks are both trained at the same time, end-to-end. Refer to equations (7) and (8), for example.

In one or more embodiments, applying the input-dependent policy network includes determining the first and second fractions based on the first fraction of input feature maps being non-redundant and the second fraction of input feature maps being redundant.

In one or more embodiments, applying the input-dependent policy network includes determining the first and second fractions for each of temporal and channel dimensions; fully computing the first corresponding output feature maps from the first fraction of input feature maps to the given convolution layer includes fully computing a temporal first fraction and a channel first fraction; and reconstructing the second corresponding output feature maps from the first corresponding output feature maps includes reconstructing a temporal first fraction and a channel first fraction.

As noted, the policy networks 131, 133 are respectively dependent on the input 129 and the output of the previous stage 135; thus, in one or more embodiments, the input-dependent policy is based on an overall input 129 for a first one of the convolution layers 135 and an output of a previous one of the convolution layers (e.g., output of 135) for subsequent ones of the convolution layers (e.g., 137).

In one or more embodiments, determining the first and second fractions for the temporal dimension and reconstructing the temporal second fraction includes dynamically scaling temporal stride in accordance with a factor, R, including two raised to a temporal policy network output based on the simultaneous joint training (R=2**pₜ to reduce computation, where pₜ is the temporal policy output by the soft modulation gate); and determining the first and second fractions for the channel dimension and reconstructing the channel second fraction includes dynamically scaling a number of output channels with a factor, r, including one-half raised to a channel policy network output based on the simultaneous joint training (r=(½)**p_{c}, where p_{c} is the channel policy).

In one or more embodiments, in the step of inputting the first corresponding output feature maps and the second corresponding output feature maps to the output layer to obtain the inference result for the final one of the convolution layers of the plurality of convolution layers of the neural network, the inference result includes a video recognition label (i.e., what does the video show, e.g., unwrapping a present, cooking eggs, playing golf, and the like). The inference result could also be, for example, a spatio-temporal action localization label (Spatio-temporal action localization is an important problem in computer vision that involves detecting where and when activities occur, and therefore requires modeling of both spatial and temporal features) or a video segmentation label (video (temporal) segmentation is the process of partitioning a video sequence into disjoint sets of consecutive frames that are homogeneous according to some defined criteria—in the most common types of segmentation, video is partitioned into shots, camera-takes, or scenes).

In one or more embodiments, the policy network and the convolutional neural network are implemented on a network edge device with limited memory/computing power (e.g., 54A, 54N).

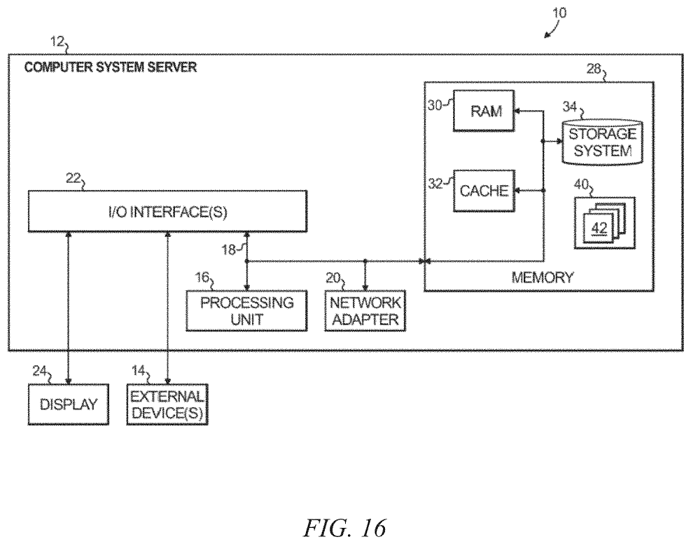

In another aspect (refer to discussion of FIG. 16), an exemplary apparatus includes a memory 28 embodying computer executable instructions 40; and at least one processor 16, coupled to the memory, and operative by the computer executable instructions to perform a method including instantiating a convolutional neural network (CNN) (e.g., blocks 135, 137) and an input-dependent policy network (e.g., 131, 133). The CNN can have an output layer. The instantiated CNN and policy network are then configured to implement any one, some, or all of the method steps described herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

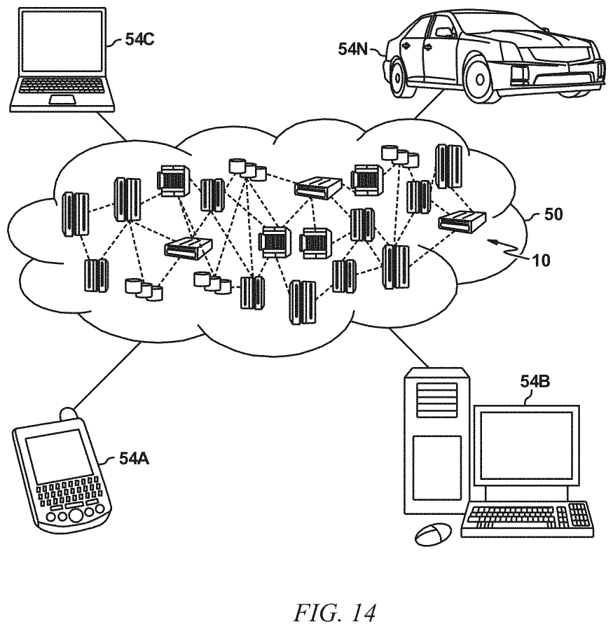

Referring now to FIG. 14, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

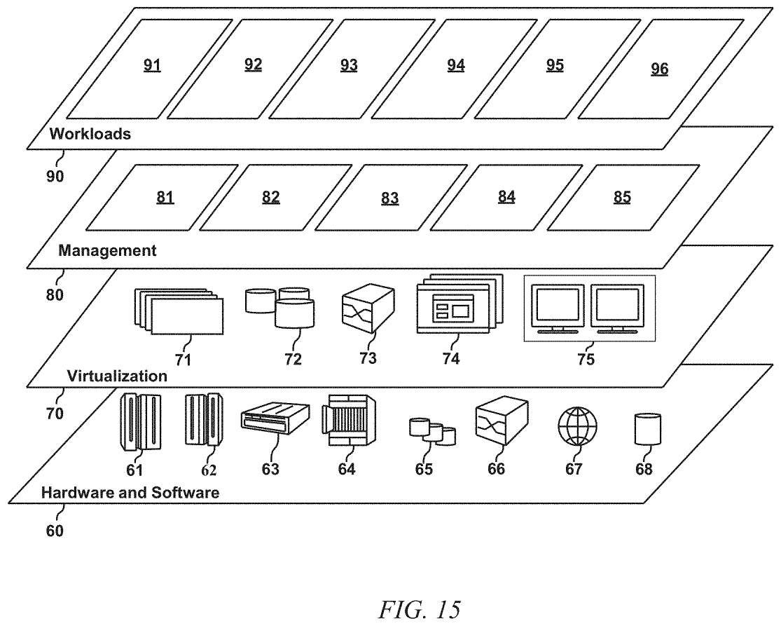

Referring now to FIG. 15, a set of functional abstraction layers provided by cloud computing environment 50 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a neural network 96 with an adaptive redundancy reduction framework configured to carry out a video processing task.

One or more embodiments of the invention, or elements thereof, can be implemented in the form of an apparatus including a memory and at least one processor that is coupled to the memory and operative to perform exemplary method steps. FIG. 16 depicts a computer system that may be useful in implementing one or more aspects and/or elements of the invention, also representative of a cloud computing node according to an embodiment of the present invention. Referring now to FIG. 16, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 16, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 16, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 16) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 14-15 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for improving the performance of a computer using a convolutional neural network to carry out a video processing task, comprising:
for each convolution layer of a plurality of convolution layers of said convolutional neural network, applying an input-dependent policy network to determine:
a first fraction of input feature maps to said given convolution layer for which first corresponding output feature maps are to be fully computed by said given convolution layer; and
a second fraction of input feature maps to said given convolution layer for which second corresponding output feature maps are not to be fully computed by said given convolution layer, but to be reconstructed from said first corresponding output feature maps;
for each convolution layer of said plurality of convolution layers of said convolutional neural network, fully computing said first corresponding output feature maps from said first fraction of input feature maps to said given convolution layer;
for each convolution layer of said plurality of convolution layers of said neural network, reconstructing said second corresponding output feature maps from said first corresponding output feature maps; and
for a final one of said convolution layers of said plurality of convolution layers of said neural network, inputting said first corresponding output feature maps and said second corresponding output feature maps to an output layer to obtain an inference result.

2. The method of claim 1, wherein applying said input-dependent policy network comprises determining said first and second fractions based on said first fraction of input feature maps being non-redundant and said second fraction of input feature maps being redundant.

3. The method of claim 2, wherein:
applying said input-dependent policy network comprises determining said first and second fractions for each of temporal and channel dimensions;
fully computing said first corresponding output feature maps from said first fraction of input feature maps to said given convolution layer comprises fully computing a temporal first fraction and a channel first fraction; and
reconstructing said second corresponding output feature maps from said first corresponding output feature maps comprises reconstructing a temporal first fraction and a channel first fraction.

4. The method of claim 3, wherein, in said applying, said input-dependent policy is based on an overall input for a first one of said convolution layers and an output of a previous one of said convolution layers for subsequent ones of said convolution layers.

5. The method of claim 4, further comprising simultaneously jointly training said convolutional neural network and said policy network.

6. The method of claim 5, wherein:
determining said first and second fractions for said temporal dimension and reconstructing said temporal second fraction comprises dynamically scaling temporal stride in accordance with a factor, R, comprising two raised to a temporal policy network output based on said simultaneous joint training; and
determining said first and second fractions for said channel dimension and reconstructing said channel second fraction comprises dynamically scaling a number of output channels with a factor, r, comprising one-half raised to a channel policy network output based on said simultaneous joint training.

7. The method of claim 4, wherein, in said step of inputting said first corresponding output feature maps and said second corresponding output feature maps to said output layer to obtain said inference result for said final one of said convolution layers of said plurality of convolution layers of said neural network, said inference result comprises a video recognition label.

8. The method of claim 4, wherein, in said step of inputting said first corresponding output feature maps and said second corresponding output feature maps to said output layer to obtain said inference result for said final one of said convolution layers of said plurality of convolution layers of said neural network, said inference result comprises a spatio-temporal action localization label.

9. The method of claim 4, wherein, in said step of inputting said first corresponding output feature maps and said second corresponding output feature maps to said output layer to obtain said inference result for said final one of said convolution layers of said plurality of convolution layers of said neural network, said inference result comprises a video segmentation label.

10. The method of claim 1, further comprising implementing said policy network and said convolutional neural network on a network edge device.

11. A computer program product comprising one or more computer readable storage media that embody computer executable instructions, which when executed by a computer using a convolutional neural network to carry out a video processing task cause the computer to perform a method comprising:
for each convolution layer of a plurality of convolution layers of said convolutional neural network, applying an input-dependent policy network to determine:
a first fraction of input feature maps to said given convolution layer for which first corresponding output feature maps are to be fully computed by said given convolution layer; and
a second fraction of input feature maps to said given convolution layer for which second corresponding output feature maps are not to be fully computed by said given convolution layer, but to be reconstructed from said first corresponding output feature maps;
for each convolution layer of said plurality of convolution layers of said convolutional neural network, fully computing said first corresponding output feature maps from said first fraction of input feature maps to said given convolution layer;
for each convolution layer of said plurality of convolution layers of said neural network, reconstructing said second corresponding output feature maps from said first corresponding output feature maps; and
for a final one of said convolution layers of said plurality of convolution layers of said neural network, inputting said first corresponding output feature maps and said second corresponding output feature maps to an output layer to obtain an inference result.

12. An apparatus comprising:
a memory embodying computer executable instructions; and
at least one processor, coupled to the memory, and operative by the computer executable instructions to perform a method comprising:
instantiating a convolutional neural network and an input-dependent policy network;
for each convolution layer of a plurality of convolution layers of said convolutional neural network, applying said input-dependent policy network to determine:
a first fraction of input feature maps to said given convolution layer for which first corresponding output feature maps are to be fully computed by said given convolution layer; and
a second fraction of input feature maps to said given convolution layer for which second corresponding output feature maps are not to be fully computed by said given convolution layer, but to be reconstructed from said first corresponding output feature maps;
for each convolution layer of said plurality of convolution layers of said convolutional neural network, with said convolutional neural network, fully computing said first corresponding output feature maps from said first fraction of input feature maps to said given convolution layer;
for each convolution layer of said plurality of convolution layers of said neural network, with said input-dependent policy network, reconstructing said second corresponding output feature maps from said first corresponding output feature maps; and
for a final one of said convolution layers of said plurality of convolution layers of said neural network, inputting said first corresponding output feature maps and said second corresponding output feature maps to an output layer of said convolutional neural network to obtain an inference result.

13. The apparatus of claim 12, wherein said input-dependent policy network is configured to determine said first and second fractions based on said first fraction of input feature maps being non-redundant and said second fraction of input feature maps being redundant.

14. The apparatus of claim 13, wherein:
said input-dependent policy network is configured to determine said first and second fractions for each of temporal and channel dimensions;
said convolutional neural network is configured to fully compute said first corresponding output feature maps from said first fraction of input feature maps to said given convolution layer by fully computing a temporal first fraction and a channel first fraction; and
said input-dependent policy network is configured to reconstruct said second corresponding output feature maps from said first corresponding output feature maps by reconstructing a temporal first fraction and a channel first fraction.

15. The apparatus of claim 14, wherein said input-dependent policy network is configured to apply said input-dependent policy based on an overall input for a first one of said convolution layers and an output of a previous one of said convolution layers for subsequent ones of said convolution layers.

16. The apparatus of claim 15, wherein said convolutional neural network and said input-dependent policy network are configured for simultaneous joint training.

17. The apparatus of claim 16, wherein said input-dependent policy network is configured to:
determine said first and second fractions for said temporal dimension and reconstruct said temporal second fraction by dynamically scaling temporal stride in accordance with a factor, R, comprising two raised to a temporal policy network output based on said simultaneous joint training; and
determine said first and second fractions for said channel dimension and reconstruct said channel second fraction by dynamically scaling a number of output channels with a factor, r, comprising one-half raised to a channel policy network output based on said simultaneous joint training.

18. The apparatus of claim 15, wherein said inference result comprises a video recognition label.

19. The apparatus of claim 15, wherein said inference result comprises a spatio-temporal action localization label.

20. The apparatus of claim 15, wherein said inference result comprises a video segmentation label.
